(19) United States
(12) Patent Application Publication
(10) Pub. No.: US 2003/0051378 A1
(43) Pub. Date: Mar. 20, 2003

(54) Patterned recreational card

(76) Inventor: Kuo-Ching Liu, Lujou City (TW)

Correspondence Address: Bruce H. Troxell, DOUGHERTY & TROXELL, 5205 Leesburg Pike, Suite 1404, Falls Church, VA, 22041, US

(21) Appl. No.: 09/951,509

(22) Filed: Sep. 14, 2001

(51) Int. Cl. G09F 1/00

(52) U.S. Cl. 40/124.191

(57) ABSTRACT

A patterned recreational card having a specific shape and being printed or otherwise processed at outer surfaces with a specific pattern, so that the card is interesting for collecting and playing. The card is also provided at outer surfaces with releasable stickers, each of which has a specific pattern shown thereon. A card collector may release the stickers from the card and attach them to a particular album or a desired place as a collection.

### FIELD OF THE INVENTION

The present invention relates to a patterned recreational card, and more particularly to a shaped card having releasable stickers printed with specific pattern to provide more funs in collecting patterns and playing the card.

### BACKGROUND OF THE INVENTION

Patterned recreational cards are one of the favorite toys among children mainly because they could be freely played in different manners and show a series of different patterns that attract children to collect them. The patterned recreational cards therefore become a main stream in the toy field.

FIG. 1 shows a conventional patterned recreational card that is basically a paper or plastic card for playing games. The card attracts children mainly because it is either specially shaped or printed with a specific pattern or design and creates funs in collecting the card.

Typically, the pattern is printed on two sides of the recreational card. For many children who love the specific patterns on the recreational cards, they would usually collect the cards once they obtain them and do not play games with the collected cards, so that the cards could be collected and maintained in their integrity without becoming damaged or dirty. Thus, the collectors are not able to enjoy funs of playing games with these collected cards.

The patterned recreational cards being collected by children are usually stacked or piled at a certain place, and must be spread for showing. Some collectors would store the collected cards in albums for conveniently sorting and showing. However, most collectors do not satisfy with these manners of collecting cards because what they really want to collect are the specific patterns and they hope to attach the favorite patterns to articles that could be carried with them at any time or to position the patterns at any place in their living space that could be seen at any time, so as to fully enjoy the collected patterns.

### SUMMARY OF THE INVENTION

Therefore, it is a primary object of the present invention to provide a patterned recreational card that enables a user to enjoy the fun of playing games with the card and collecting specific pattern that could be released from the card for attaching to any desired place.

To achieve the above object, the patterned recreational card of the present invention mainly includes a card body, two outer surfaces of which are provided with releasable stickers. The stickers are printed with specific patterns the same as patterns directly printed on two surfaces of the card body. Thus, a collector may release the stickers showing favorite patterns from the card body for attaching to desired places and uses the card body to play games without worrying damaged or dirty patterns on the card.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional patterned recreational card;

FIG. 2 is an exploded perspective view of a patterned recreational card of the present invention showing separated patterned stickers and card body thereof;

FIG. 3 is a fragmentary, enlarged, and assembled sectional view of the patterned recreational card of the present invention; and

FIG. 4 shows the patterned stickers are partially released from the card body before the patterned recreational card of the present invention is used to play games.

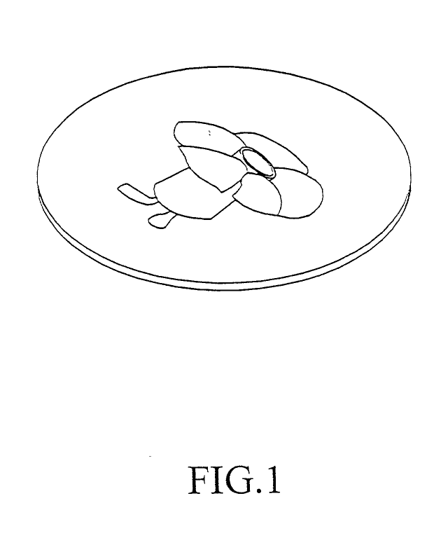

### DETAILED DESCRIPTION OF THE PREFERRED EMBODIMENTS

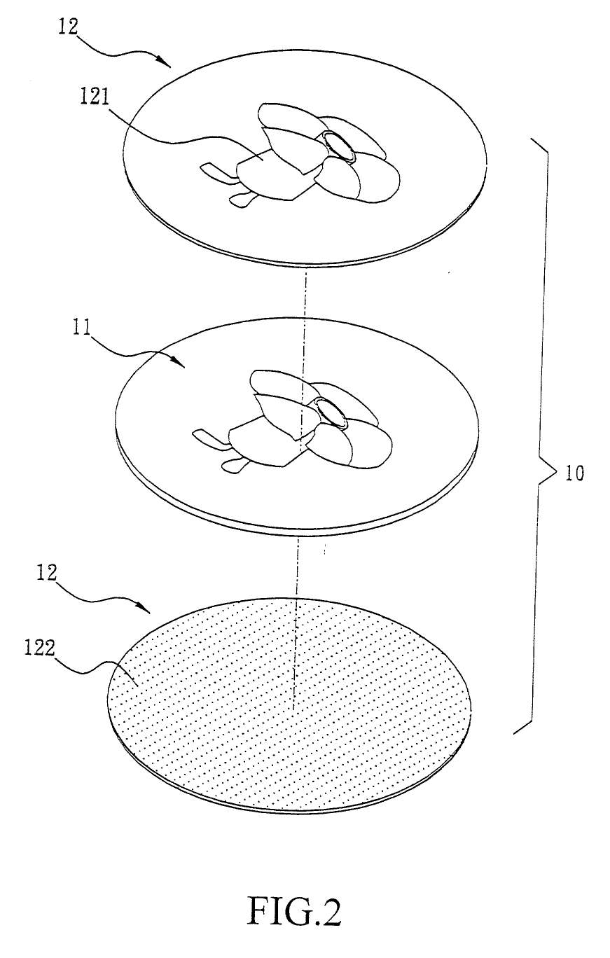

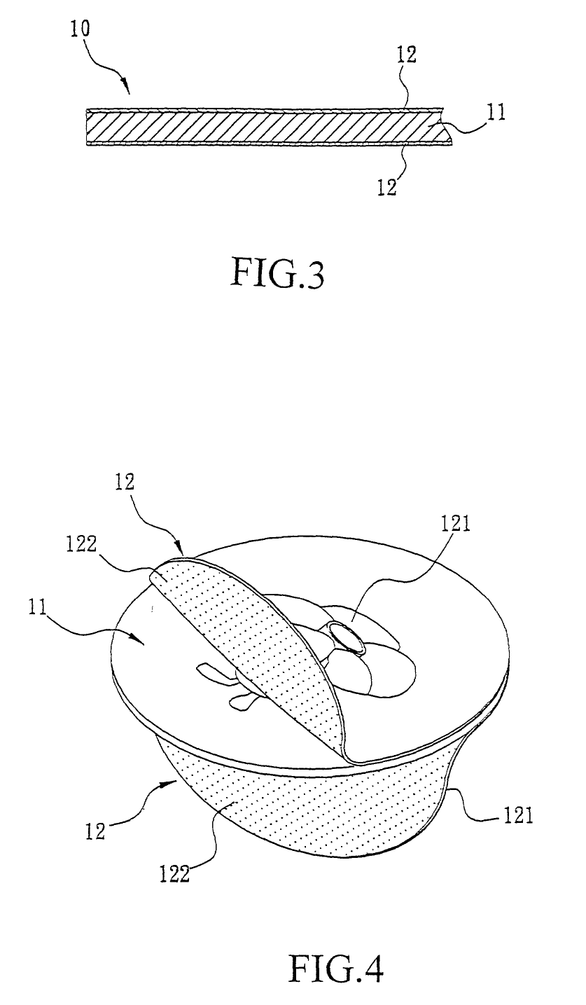

Please refer to FIGS. 2 and 3 that are exploded perspective and assembled sectional views, respectively, of a patterned recreational card 10 according to an embodiment of the present invention. As shown, the patterned recreational card 10 mainly includes a card body 11, and at least one sticker 12 adapted to stick to an outer surface of the card body 11. The card body 11 is a specially shaped flat member made of paper or plastics and has two parallel outer surfaces. At least one of the two outer surfaces of the card body 11 is provided with a specific pattern through printing or other suitable means.

Each sticker 12 is a thin sheet made of paper or plastics similar to that for making the card body 11. One side of the sticker 12 is a patterned surface 121 on which a specified pattern is shown, and the other side of the sticker 12 is a gummed surface 122 on which a suitable bonding material, such as general adhesive, is applied, so that the sticker 12 may be attached at the gummed surface 122 to one outer surface of the card body 11.

The pattern to be shown on the patterned surface 121 of the sticker 12 may be decided depending on a specific design and may be the same as or different from the pattern printed on the at least one outer surface of the card body 11. Moreover, the pattern shown on the patterned surface 121 of the sticker 12 may be a plane design or a three-dimensional design slightly raised from a plane defined by the sticker 12.

When a collector obtains a patterned recreational card 10, he or she may release the stickers 12 from the card body 11, as shown in FIG. 4, and discretionally attaches the released stickers 12 to a desired place to form a part of his or her precious collections. The card body 11 showing the printed pattern after removal of the stickers 12 may still be used as a recreational means to play many different games. Thus, the patterned recreational card 10 of the present invention has not only value for collection but also funs for playing.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A patterned recreational card, comprising:
a card body being an integral and specially shaped flat member having two parallel outer surfaces, and at least one of said two outer surfaces being provided with a specific pattern; and
at least one sticker having a patterned surface showing a specific pattern and a gummed surface being applied with a suitable bonding material for removably sticking to any one of said two outer surfaces of said card body.

2. The patterned recreational card as claimed in claim 1, wherein pattern shown on said at least one outer surface of said card body is printed onto said card body.

3. The patterned recreational card as claimed in claim 1, wherein said bonding material applied on said gummed surface of said at least one sticker is an adhesive.
